(19) United States
(12) Patent Application Publication
(10) Pub. No.: US 2002/0158435 A1
(43) Pub. Date: Oct. 31, 2002

(54) Trolley for staging modules

(76) Inventors: Guy Cathles Hill, Cheshire (GB); Geoffrey Ferguson Crawford, Knutsford (GB); Matthew William Howard, Belper (GB)

Correspondence Address: Thomas Q Henry, Woodard Emhardt Naughton Moriarty & McNett, Bank One Tower, 111 Monument Circle Suite 3700, Indianapolis, IN, 46204, US

(21) Appl. No.: 09/913,549

(22) PCT Filed: Dec. 14, 2000
(86) PCT No.: PCT/GB00/04779

(30) Foreign Application Priority Data
Dec. 15, 1999 (GB) 9929630.3

(51) Int. Cl. B62B 3/04; B62B 3/10

(52) U.S. Cl. 280/47.35; 280/79.3

(57) ABSTRACT

A trolley (1) configured to carry a plurality of staging modules (7) in a storage orientation, the trolley being provided with pivot means (10) which allow a staging module to be rotatably moved from the storage orientation to a deployment orientation.

The present invention relates to a trolley for carrying staging modules.

Removable staging is commonly used in many applications, for example staging may periodically be required in a function room of a hotel, or in a school assembly room. The staging is stored away from the function room or assembly room when it is not in use.

A first known type of removable staging comprises individual staging modules, typically having a surface area of around one square metre, which are arranged together to provide a stage of a desired size and shape. The staging modules are commonly provided with legs which act to raise the level of the stage. The legs may be removable to allow compact storage of the staging modules. Alternatively, the legs may be foldable against an underside of each staging module, again to allow compact storage of the staging modules. A disadvantage of this form of staging is that each staging module must be carried from a storage location to a location in which the stage is to be erected. The staging modules cannot easily be carried by a single person, and it is both time consuming and labour intensive to carry individual staging modules from a storage location, and then erect them.

A second known form of removable staging is produced by Stageright Corporation, and is referred to as “fold and roll” staging. Again, this staging is modular, with staging modules being placed together to provide a stage area. Fold and roll staging modules are constructed in a similar manner to a table-tennis table, and are moveable from an open configuration to a closed configuration. In the open configuration, a staging module provides a stage surface area comprising two adjacent platforms supported by legs. In the closed configuration, the two platforms are vertically oriented with facing inner surfaces. The legs may be folded to a storage position to minimise the volume occupied by the staging when it is in the closed configuration. The staging is provided with wheels which allow it to be moved by a single person when in the closed configuration. A disadvantage of this form of staging is that it is complex, and expensive to produce. Furthermore, the staging occupies a significant volume when deployed in the closed configuration.

It is an object of the present invention to provide a trolley which overcomes at least one of the above disadvantages.

According to the invention there is provided a trolley configured to carry a plurality of staging modules in a storage orientation, the trolley being provided with pivot means which allow a staging module to be rotatably moved from the storage orientation to a deployment orientation.

Preferably, the storage orientation is substantially vertical.

The trolley according to the invention is advantageous because it allows a plurality of staging modules to be moved to a required location by a single operator. The operator may remove a staging module from the trolley by pivoting the staging module to a substantially horizontal orientation (the deployment orientation).

Preferably, the pivot means is located at or adjacent a lowermost end of the staging module, such that pulling an uppermost end of the staging module will cause the staging module to rotatably move about the pivot means.

Preferably, the trolley is provided with a release mechanism configured to release the staging module from the trolley when the staging module approaches the deployment orientation.

Preferably, the height of the trolley relative to the length of legs of the staging module is such that the legs of the staging module will contact ground as the staging module approaches the deployment orientation, and further rotation of the staging module towards the deployment orientation will lift the staging module clear of the trolley. The release mechanism is in effect the height of the trolley relative to the length of the legs of the staging module.

Preferably, the trolley comprises a staging module supporting surface which is provided with at least one recess into which a lower surface of the staging module may be located.

Preferably, the at least one recess acts as the pivot means by resisting movement of the lower surface of the staging module with respect to the staging module supporting surface when the staging module is rotatably moved from the storage orientation to the deployment orientation

Preferably, the staging module supporting surface is made from nylon, the at least one recess being provided in the nylon.

Preferably, the trolley comprises two members fixed to a frame.

Suitably, wheels are mounted on the members.

Suitably, transversely extending supports are fixed to the frame, and wheels are mounted on the supports.

Preferably, the supports are fixed to the frame at a point above a lowermost end of the frame. This provides the trolley with a low centre of gravity.

Preferably, the trolley further comprises at least one upper member which extends from an upper portion of the frame.

Preferably, the trolley is provided with at least one locking device for restricting movement of the staging module

Preferably, the at least one locking device comprises a rod pivotally mounted on the trolley such that in a locked orientation it will extend across part of the staging module thereby restricting its movement, and in an open orientation it will not extend across part of the staging module.

Preferably, the rod is provided with securing means for securing the rod in the locked orientation.

Preferably, the securing means comprises a resiliently mounted ball arranged to locate in a correspondingly dimensioned opening when the rod is in the locked orientation.

Preferably, the locking device is provided on the at least one upper member mentioned above.

Preferably, the trolley is provided with height adjustment means for modifying the clearance of the trolley from the ground.

A specific embodiment of the invention will now be described with reference to the accompanying figures, in which.

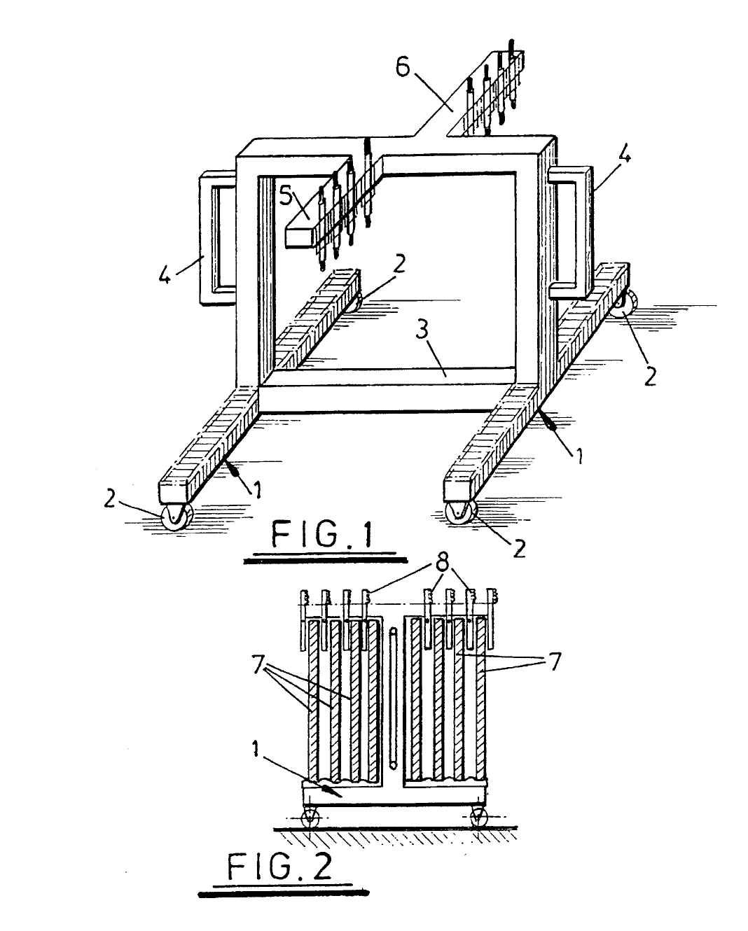

FIG. 1 is a schematic perspective view of a first embodiment of a trolley according to the invention;

FIG. 2 is a schematic side view of the trolley of FIG. 1;

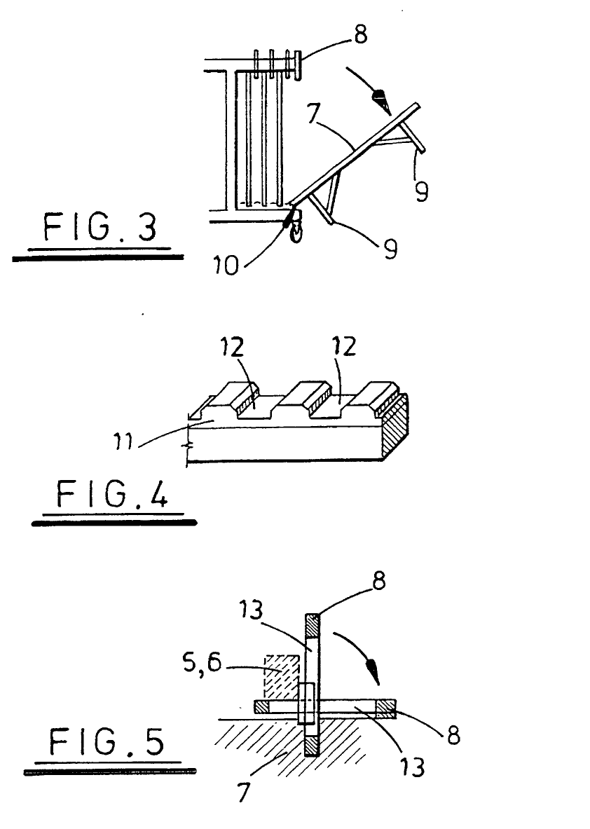

FIG. 3 is a schematic side view illustrating operation of the trolley shown in FIGS. 1 and 2;

FIG. 4 is a schematic perspective view of part of a base of the trolley;

FIG. 5 is a schematic side view of a locking mechanism comprising part of the trolley; and

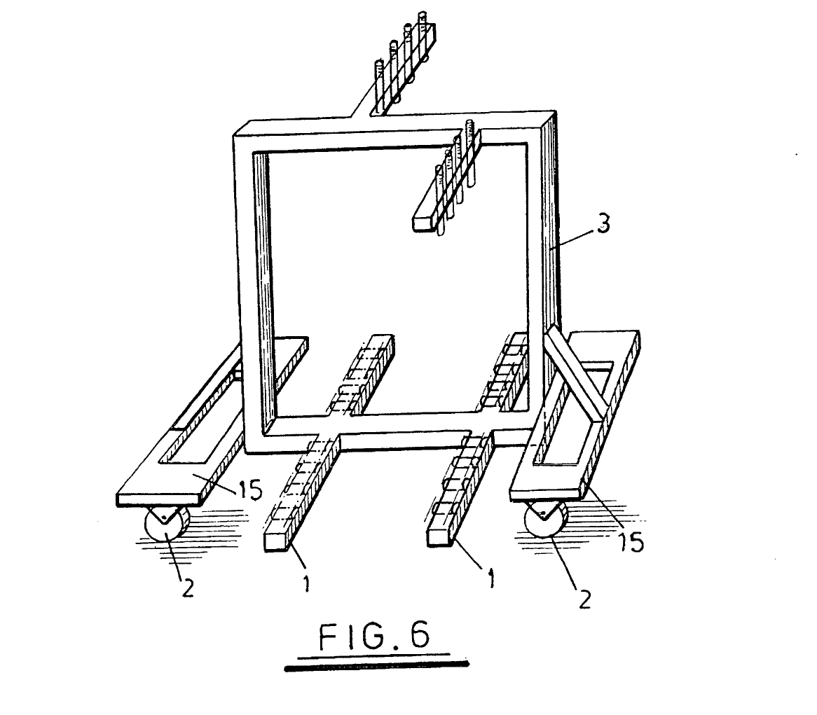

FIG. 6 is a schematic perspective view of an alternative embodiment of a trolley according to the invention.

Referring first to FIG. 1, a trolley comprises a pair of parallel members 1 supported by castors 2 and separated by a rectangular frame 3. The rectangular frame 3 is provided with handles 4 to allow the trolley to be moved easily by a single operator. First and second spars 5, 6 project from an upper part of the frame 3.

Referring to FIG. 2, staging modules 7 rest upon, and are supported by, the members 1. Locking means 8 are located between each staging module 7, thereby holding each staging module 7 in position on the trolley. The locking means 8 are described in detail below, and illustrated in FIG. 5.

Staging modules 7 are moved from a storage location to a function room or assembly room using the trolley. The staging modules 7 are deployed sequentially, starting with an outermost module 7 at an end of the trolley. Foldable legs 9, as shown in FIG. 3, are moved to an outwardly projecting orientation prior to deployment of a given staging module. An outmost locking means 8 is moved from a locked configuration to an open configuration, thereby allowing movement of an upper portion of the staging module 7 The upper portion of the staging module 7 is pulled outwards, causing the staging module 7 to pivot about an axis located at and traverse to the members 1. The location of the pivot axis is indicated in FIG. 3 by an arrow 10. The pivot action allows the staging module 7 to be moved to a horizontal orientation in a controlled manner

The height of the members 1 is such that those legs 9 of the staging module 7 which arc closest to the trolley will contact the ground shortly before the staging module 7 has reached a horizontal orientation. The staging module 7 will then pivot about an axis located at the base of the legs 9, thereby lifting the staging module 7 away from the trolley until the staging module 7 is in a horizontal orientation with the remaining legs 9 in contact with the ground.

Subsequent staging modules 7 are deployed in the same manner.

The members 1, frame 3, handles 4 and spars 5, 6 are fabricated from a suitable metal, for example steel or aluminum.

FIG. 4 shows in detail part of one of the members 1. An upper surface of the member 1 is provided with a layer of nylon 11 into which a series of recesses 12 are cut. A lowermost end of each staging module 7 is held in a pair of recesses 12 (one recess 12 per member 1) When a staging module 7 is being pivoted to a horizontal orientation, as shown in FIG. 3, the axis of the pivot is located within the recesses 12. The staging module is prevented by the recesses 12 from slipping along the members 1 as it is being pivoted, and in this sense the recesses 12 may be considered to be pivot means.

Referring to FIG. 5, the locking mechanism 8 comprises a rod 13 pivotally mounted on one of the spars 5, 6 with a pivot axis lying parallel to a major access of the spar 5, 6. In a closed configuration the rod 13 is held in a vertical orientation such that a lower portion of the rod 13 projects below an upper surface of a staging unit 7, thereby restricting movement of the upper surface of the staging unit 7. In an open configuration the rod 13 is in a horizontal orientation such that the entirety of the rod 13 is located above the upper surface of the staging unit 7, thereby allowing free movement of the upper surface of the staging unit 7. The rod 13 may be held in the vertical orientation by a securing device (not shown). The securing device may be for example a resiliently mounted ball arranged to locate in a correspondingly dimensioned opening when the rod 13 is in the vertical orientation.

The wheels 2 of the trolley may be held on height adjustable mountings (not shown) which allow the clearance of the trolley to be raised and lowered. This is advantageous because it allows the height of the trolley to be set such that, referring to FIG. 3, legs 9 of a staging module 7 will contact the ground shortly before the staging module 7 reaches a horizontal orientation.

The wheels 2 may be provided with brakes (not shown) to prevent movement of the trolley as the staging modules 7 are being deployed.

An alternative embodiment of the invention is shown in FIG. 6. In the alternative embodiment of the invention the members 1 are not directly supported by castors Instead, castors 2 are provided on transversely extending supports 15. The supports 15 are fixed to the frame 3 at a position partway above the base of the frame 3. Consequently, the members 1 are closer to the ground than the members of the embodiment of the invention shown in FIG. 1. This feature of the alternative embodiment of the invention provides enhanced stability of the trolley when it is in motion.

It will be appreciated that the invention may be implemented in a variety of forms. In particular, the pivot means may not be recesses provided in a pair of members 1, but may be any other suitable form of pivot means. For example, the trolley may be provided with a pair of vertically spaced parallel rails (not shown) supported by the members 1, and the staging modules 7 may be provided with rods for location between the rails. The staging modules 7 would then be supported by the rails, via the rods, and would be free to rotate about a pivot axis defined by the rods. In a further alternative example, the rods may be replaced with ball bearings, and the rails replaced with ball bearing slides (not shown).

1. A trolley configured to carry a plurality of staging modules in a storage orientation, the trolley being provided with pivot means which allow a staging module to be rotatably moved from the storage orientation to a deployment orientation.

2. A trolley according to claim 1, wherein the storage orientation is substantially vertical.

3. A trolley according to claim 1 or 2, wherein the pivot means is located at or adjacent a lowermost end of the staging module, such that pulling an uppermost end of the staging module will cause the staging module to rotatably move about the pivot means.

4. A trolley according to claim 1,2 or 3 wherein the trolley is provided with a release mechanism configured to release the staging module from the trolley when the staging module approaches the deployment orientation.

5. A trolley according to claim 4, wherein the height of the trolley relative to the length of legs of the staging module is such that the legs of the staging module will contact ground as the stains module approaches the deployment orientation, and further rotation of the staging module towards the deployment orientation will lift the staging module clear of the trolley.

6. A trolley according to any preceding claim, wherein the trolley comprises a staging module supporting surface which is provided with at least one recess into which a lower surface of the staging module may be located.

7. A trolley according to claim 6, wherein the at least one recess acts as the pivot means by resisting movement of the lower surface of the staging module with respect to the staging module supporting surface when the staging module is rotatably moved from the storage orientation to the deployment orientation

8. A trolley according to claim 6 or 7, wherein the staging module supporting surface is made from nylon, the at least one recess being provided in the nylon.

9. A trolley according to any preceding claim, wherein the trolley comprises two members fixed to a frame.

10. A trolley according to claim 9, wherein wheels are mounted on the members.

11. A trolley according to claim 9, wherein transversely extending supports are fixed to the frame, and wheels are mounted on the supports.

12. A trolley according to claim 11, wherein the supports are fixed to the frame at a point above a lowermost end of the frame.

13. A trolley according to any of claims 9 to 12, wherein the trolley further comprises at least one upper member which extends from an upper portion of the frame

14. A trolley according to any preceding claim, wherein the trolley is provided with at least one locking device for restricting movement of the staging module.

15. A trolley according to claim 14, wherein the at least one locking device comprises a rod pivotally mounted on the trolley such that in a locked orientation it will extend across part of the staging module thereby restricting its movement, and in an open orientation it will not extend across part of the staging module.

16. A trolley according to claim 15, wherein the rod is provided with securing means for securing the rod in the locked orientation.

17. A trolley according to claim 16, wherein the securing means comprises a resiliently mounted ball arranged to locate in a correspondingly dimensioned opening when the rod is in the locked orientation.

18. A trolley according to any of claims 14 to 17 as dependent upon claim 13, wherein the locking device is provided on the at least one upper member.

19. A trolley according to any preceding claim, wherein the trolley is provided with height adjustment means for modifying the clearance of the trolley from the ground.

20. A trolley substantially as hereinbefore described with reference to the accompanying figures.
